(19) United States
(12) Patent Application Publication
(10) Pub. No.: US 2026/0307063 A1
(43) Pub. Date: Oct. 8, 2026

(54) HIGHLY DISPERSED METAL CARBONATE CATALYSTS

(71) Applicant: BASF CORPORATION, Florham Park, NJ (US)

(72) Inventors: Jian-Ping Chen, Beachwood, OH (US); Carlos Lizandara Pueyo, Ludwigshafen am Rhein (DE); Abdulnaser Abdulrahman Dahbali, Elyria, OH (US)

(73) Assignee: BASF CORPORATION, Florham Park, NJ (US)

(21) Appl. No.: 19/483,098

(22) PCT Filed: May 20, 2024
(86) PCT No.: PCT/US2024/030210

§ 371 Date: Nov. 10, 2025

Related U.S. Application Data
(60) Provisional application No. 63/469,084, filed on May 26, 2023.

(51) Int. Cl. B01J 27/232; B01J 21/04; B01J 21/08; B01J 37/04; C01B 32/40

(52) U.S. Cl. CPC B01J 27/232; B01J 21/04; B01J 21/08; B01J 37/04; C01B 32/40

(57) ABSTRACT

Disclosed herein is a catalyst including a metal carbonate including potassium, cesium, or sodium and a support. The metal carbonate is amorphous. A method of preparing the catalyst is also provided. A method of performing a reversed water gas shift reaction including the catalyst as described herein is also provided.

### CROSS REFERENCE TO RELATED APPLICATION(S)

The present application claims priority to U.S. Provisional Patent Application No. 63/469,084 filed on May 26, 2023, where the contents of which are incorporated herein in its entirety.

### FIELD OF THE INVENTION

The present invention relates to a catalyst including a metal carbonate. The metal carbonate may be highly dispersed throughout the catalyst and may be selected from potassium (K), cesium (Cs), or sodium (Na).

### BACKGROUND OF THE INVENTION

Metal carbonate catalysts have been prepared for applications in sustainable chemical process that results in low carbon or negative carbon emission. A series of catalysts, carbon, alumina and silica supported Na₂CO₃, K₂CO₃ or Cs₂CO₃ were prepared for CO₂ utilization applications. Over time, it was found that these catalysts may catalyze CO₂ hydrogenation to produce syngas that can be further processed into methanol, ethanol, higher hydrocarbon fuel and high value petrochemical without using fossil oil or natural gas. The carbon source comes from greenhouse gas carbon dioxide. These result in carbon negative chemical production by using green hydrogen.

Catalysts used in a reversed water gas shift (RWGS) reaction, need higher operation temperature, and have low selectivity due to methane formation. Thus, there is a need in the art to develop a catalyst that can operate at lower temperatures, while avoiding no methane formation. Such catalyst may have cost savings for operators and processors.

### SUMMARY OF THE INVENTION

Disclosed herein in an embodiment is a catalyst. In an embodiment, the catalyst includes a metal carbonate including K, Cs, or Na, and a support, wherein the metal carbonate is amorphous.

In some embodiments, the support may include carbon, alumina, silica, or a combination thereof.

In some embodiments, the metal carbonate may include K. In other embodiments, the metal carbonate may include Cs. In yet another embodiment, the metal carbonate may include Na.

In some embodiments, the metal carbonate may be included in an amount of about 10% to about 45% by weight, based on total weight of the catalyst. In some embodiments, the metal carbonate may be included in an amount of about 15% to about 40% by weight, based on total weight of the catalyst. In some embodiments, the metal carbonate may be included in an amount of about 20% to about 35% by weight, based on total weight of the catalyst.

In some embodiments, the support may be an alumina support.

In some embodiments, the support may be a carbon support. In some embodiments, the carbon support may be activated carbon.

In some embodiments the support may be a silica support.

In some embodiments, the catalyst may have high activity for CO₂ hydrogenation. In some embodiments, the catalyst may have high selectivity to CO at a temperature of about 350° C. to about 750°. In other embodiments, the catalyst may have selectivity to CO at a temperature of about 375° C. to about 725° C., about 400° C. to about 700° C., about 425° C. to about 675° C., about 450° C. to about 650° C., about 475° C. to about 625° C., about 500° C. to about 600° C., or about 525° C. to about 575° C., or any value or sub range herein.

In some embodiments, a method of preparing a catalyst is provided. The method may include mixing the metal carbonate and the support.

In some embodiments, the method may further include spraying the metal carbonate solution on the support.

In some embodiments, the method may further include drying the catalyst.

In some embodiments, the method may further include calcining the catalyst at a temperature of about 300° C. to about 700° C.

In another embodiment, a method for performing a reverse water gas shift reaction including the catalyst is provided.

In some embodiments of the method, the CO yield after reaction was about 40% to about 50% with 100% selectivity at a temperature of about 440° C.

In some embodiments, the catalyst may have about 100% CO selectivity from 350° C. to about 500° C., and at least about 98% CO selectivity at a temperature up to about 650° C.

In some embodiments, the method may produce less than about 1% methane up to about 500° C. and less than 5% at up to about 650° C.

In some embodiments, the reversed water gas shift (“RWGS”) reaction may be performed at a temperature of about 350° C. to about 750° C.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 illustrates the XRD results of 26% Cs₂CO₃ on silica calcined at 300° C. from Example 6;

FIG. 2 illustrates the XRD results of 26% Cs₂CO₃ on silica calcined at 700° C. from Example 6; and

FIG. 3 illustrates the XRD results of 16.67% K₂CO₃ on alumina support from Example 12.

### DETAILED DESCRIPTION OF THE INVENTION

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “a” or “an” entity refers to one or more of that entity, e.g., “a compound” refers to one or more compounds or at least one compound unless stated otherwise. As such, the terms “a” (or “an”), “one or more”, and “at least one” are used interchangeably herein.

As used herein, the term “and/or” includes any and all combinations of one or more of the associated listed items. Additionally, as used herein, “or” means “and/or.”

Most catalysts used in a reverse water gas shift (“RWGS”) reaction are metal catalysts that are supported nickel (Ni) or a precious metal. These metal catalysts normally need higher operation temperatures, such as above 700° C., and have lower selectivity than the catalyst of the present disclosure. These metal catalysts normally need to operate in a pressure of about 1 to 100 bar, while the catalyst of the present disclosure can operate at a lower pressure of about 1 bar. Additionally, the gas hourly space velocity (GHSV) of the catalyst may be about 100 to about 1000000 h⁻¹. The lower selectivity of the current metal catalysts being used is believed to be because of methane formation during the RWGS reaction.

The catalyst of the present disclosure addresses these issues because it can be effective at lower operating temperatures and still have high selectivity during the reaction, particularly at a temperature range of about 400° C. to about 650° C., where almost no methane is formed. Therefore, the catalyst of the present disclosure will have significant cost saving for the operators and processers of the reaction. The syngas produced from this inventive catalyst will result in low or even negative carbon emission for value added chemicals and fuels synthesis. Any intermediates produced in reactions may be further processed into other value chemical building blocks that are normally synthesized by using petroleum, natural gas or coal. Thus, chemical production will be more sustainable using the metal carbonate catalyst of the present disclosure.

In an embodiment of the present disclosure, a catalyst including a metal carbonate is provided. The metal carbonate includes potassium (K), cesium (Cs), or sodium (Na), wherein the metal carbonate is amorphous. The catalyst further includes a support.

In some embodiments, the metal carbonate may include K. In other embodiments, the metal carbonate may include Cs. In yet another embodiment, the metal carbonate may include Na.

In some embodiments, the metal carbonate may be included in an amount of about 10% to about 45% by weight, based on total weight of the catalyst. In some embodiments, the metal carbonate may be included in an amount of about 15% to about 40% by weight, based on total weight of the catalyst. In some embodiments, the metal carbonate may be included in an amount of about 20% to about 35% by weight, based on total weight of the catalyst. In some embodiments, the metal carbonate may be included in an amount of about 25% to about 30% by wight, based on total weight of the catalyst. In some embodiments, the metal carbonate may be included in an amount of about 10%, about 15%, about 20%, about 25%, about 30%, about 35%, about 40%, or about 45%.

In some embodiments, the support may be a metal oxide. The metal oxide may include alumina, silica, zirconia, titania, ceria, tin oxide, and the like, and combinations thereof.

In some embodiments, the support may include carbon, alumina, silica, or a combination thereof. In some embodiments, the support may be an alumina support. The alumina support may include pseudoboehmite alumina, boehmite, gamma-alumina, χ-alumina, δ-alumina, θ-alumina, κ-alumina, or combination thereof. The alumina support may also be an activated alumina. In some embodiments, the alumina may be doped alumina, such as Si-doped alumina.

In some embodiments, the support may be a carbon support. The carbon support may include an activated carbon, or graphite. In some embodiments, the carbon support may be a carbine. In some embodiments, the carbon support may include TiC, ZrC, HfC, TaC, boron carbide, boron-oxy-carbide, or boron carbides.

In some embodiments, the support may be a silica support. In some embodiments, the silica support may include silica, or silica-alumina.

In some embodiments, the catalyst may have high activity for CO₂ hydrogenation. In some embodiments, the catalyst may be used in a carboxylation reaction. In some embodiments, the carboxylation reaction may be a C—H carboxylation, a benzene carboxylation, or a heteroarene carboxylation.

In some embodiments, the catalyst may have high selectivity to CO during a RWGS reaction. In some embodiments, during a RWGS reaction, methane may not be detected.

In some embodiments, the catalyst may be used in a hydrocarbon esterification cycle. In such cycle, the catalyst may have high selectivity and limit the production of corrosive oxidations.

In some embodiments, the catalyst may be used in a process for preparing an oxalate.

In some embodiments, the catalyst may have a high selectivity to CO at a temperature of about 350° C. to about 750° C. In some embodiments, the catalyst may have a high selectivity to CO at a temperature of about 375° C. to about 725° C., about 400° C. to about 700° C., about 425° C. to about 675° C., about 450° C. to about 650° C., about 475° C. to about 625° C., about 500° C. to about 600° C., or about 525° C. to about 575° C. In some embodiments, the catalyst may have a high selectivity to CO at a temperature of about 350° C., about 375° C., about 400° C., about 425° C., about 450° C., about 475° C., about 500° C., about 525° C., about 550° C., about 575° C., about 600° C., about 625° C., about 650° C., about 675° C., about 700° C., about 725° C., or about 750° C.

In another embodiment, a method of preparing a catalyst is provided. The method includes mixing the metal carbonate and the support. In some embodiments, the metal carbonate may include K, Cs, or Na, wherein the metal carbonate is amorphous.

In some embodiments, the metal carbonate may include K. In other embodiments, the metal carbonate may include Cs. In yet another embodiment, the metal carbonate may include Na.

In some embodiments, the metal carbonate may be included in an amount of about 10% to about 45% by weight, based on total weight of the catalyst. In some embodiments, the metal carbonate may be included in an amount of about 15% to about 40% by weight, based on total weight of the catalyst. In some embodiments, the metal carbonate may be included in an amount of about 20% to about 35% by weight, based on total weight of the catalyst. In some embodiments, the metal carbonate may be included in an amount of about 25% to about 30% by wight, based on total weight of the catalyst. In some embodiments, the metal carbonate may be included in an amount of about 10%, about 15%, about 20%, about 25%, about 30%, about 35%, about 40%, or about 45%.

In some embodiments, the support may be a metal oxide. The metal oxide may include alumina, silica, zirconia, titania, ceria, tin oxide, and the like, and combinations thereof.

In some embodiments, the support may include carbon, alumina, silica, or a combination thereof. In some embodiments, the support may be an alumina support. The alumina support may include pseudoboehmite alumina, boehmite, gamma-alumina, χ-alumina, δ-alumina, θ-alumina, κ-alumina, or combination thereof. The alumina support may also be an activated alumina. In some embodiments, the alumina may be doped alumina, such as Si-doped alumina.

In some embodiments, the support may be a carbon support. The carbon support may include an activated carbon, or graphite. In some embodiments, the carbon support may be a carbine. In some embodiments, the carbon support may include TiC, ZrC, HfC, TaC, boron carbide, boron-oxy-carbide, or boron carbides.

In some embodiments, the support may be a silica support. In some embodiments, the silica support may include silica, or silica-alumina.

In some embodiments, the method may include spraying the metal carbonate solution on the support. In some embodiments, the method may further include drying the catalyst.

In some embodiments, the method may further include calcining the catalyst at a temperature of about 300° C. to about 700° C. In some embodiments, the calcining may be performed at a temperature of about 325° C. to about 675° C., about 350° C. to about 650° C., about 375° C. to about 625° C., about 400° C. to about 600° C., about 425° C. to about 575° C., about 450° C. to about 550° C., or about 475° C. to about 525° C. In other embodiments, the calcining may be performed at a temperature of about 300° C., about 325° C., about 350° C., about 375° C., about 400° C., about 425° C., about 450° C., about 475° C., about 500° C., about 525° C., about 550° C., about 575° C., about 600° C., about 625° C., about 650° C., about 675° C., or about 700° C.

In some embodiments, a method for performing a reversed water gas shift (RWGS) reaction is provided. The method includes applying the catalyst as described herein. For example, the catalyst includes a metal carbonate. The metal carbonate includes K, Cs, or Na, wherein the metal carbonate is amorphous. The catalyst further includes a support.

In some embodiments, the metal carbonate may include K. In other embodiments, the metal carbonate may include Cs. In yet another embodiment, the metal carbonate may include Na.

In some embodiments, the metal carbonate may be included in an amount of about 10% to about 45% by weight, based on total weight of the catalyst. In some embodiments, the metal carbonate may be included in an amount of about 15% to about 40% by weight, based on total weight of the catalyst. In some embodiments, the metal carbonate may be included in an amount of about 20% to about 35% by weight, based on total weight of the catalyst. In some embodiments, the metal carbonate may be included in an amount of about 25% to about 30% by wight, based on total weight of the catalyst. In some embodiments, the metal carbonate may be included in an amount of about 10%, about 15%, about 20%, about 25%, about 30%, about 35%, about 40%, or about 45%.

In some embodiments, the support may be a metal oxide. The metal oxide may include alumina, silica, zirconia, titania, ceria, tin oxide, and the like, and combinations thereof.

In some embodiments, the support may include carbon, alumina, silica, or a combination thereof. In some embodiments, the support may be an alumina support. The alumina support may include pseudoboehmite alumina, boehmite, gamma-alumina, χ-alumina, δ-alumina, θ-alumina, κ-alumina, or combination thereof. The alumina support may also be an activated alumina. In some embodiments, the alumina may be doped alumina, such as Si-doped alumina.

In some embodiments, the support may be a carbon support. The carbon support may include an activated carbon, or graphite. In some embodiments, the carbon support may be a carbine. In some embodiments, the carbon support may include TiC, ZrC, HfC, TaC, boron carbide, boron-oxy-carbide, or boron carbides.

In some embodiments, the support may be a silica support. In some embodiments, the silica support may include silica, or silica-alumina.

In some embodiments of the RWGS, the CO yield after reaction was about 40% to about 50% with 100% selectivity at a temperature of about 440° C.

In some embodiments of the RWGS, the catalyst may have about 100% CO selectivity from about 350° C. to about 500° C. In some embodiments of the RWGS, the catalyst may have at least about 98% CO selectivity at a temperature of up to about 650° C. In some embodiments, the catalyst may have at least about 98% CO selectivity at a temperature of about 500° C., about 525° C., about 550° C., about 575° C., about 600° C., about 625° C., or about 650° C.

In some embodiments, the RWGS reaction may produce less than about 1% methane at a temperature of up to about 500° C. In some embodiments, the RWGS reaction may produce less than about 5% methane at a temperature up to about 650° C. In some embodiments, the RWGS reaction may not produce methane at a temperature of up to about 500° C. In some embodiments, the RWGS reaction may produce less than about 1% methane at a temperature of about 350° C. to about 500° C., about 375° C. to about 475° C., or about 400° C. to about 450° C. In some embodiments, the RWGS reaction may produce less than 5% methane at a temperature of about 350° C. to about 650° C., about 375° C. to about 625° C., about 400° C. to about 600° C., about 425° C. to about 575° C., about 450° C. to about 550° C., or about 475° C. to about 525° C.

In some embodiments, the RWGS reaction may be performed at a temperature of about 350° C. to about 750° C., about 375° C. to about 725° C., about 400° C. to about 700° C., about 425° C. to about 675° C., about 450° C. to about 650° C., about 475° C. to about 625° C., about 500° C. to about 600° C., or about 525° C. to about 575° C.

### EXAMPLES

Specific embodiments of the invention will now be demonstrated by reference to the following examples. It should be understood that these examples are disclosed solely by way of illustrating the invention and should not be taken in any way to limit the scope of the present invention.

### Catalyst Preparation Procedures

### Example 1

A catalyst was prepared as follows to have 38.14% K₂CO₃ on silica. 40.0 g of silica sphere and 51.0 g of 50% K₂CO₃ solution was weighed. A rotary impregnation was set up to spray the 50% K₂CO₃ solution on to the silica sphere at a given rate. The rotary impregnation was rotated for about 5 to about 10 minutes, where the catalysts were observed for any uniformity change. The impregnated sample was left to sit at room temperature for at least 30 minutes. After sitting, the sample was then dried at 120° C. for at least 4 hours. The dried samples were then calcined at 300° C., 400° C., 500° C., 600° C., and 700° C.

### Example 2

A catalyst was prepared as follows to have 26.8% K₂CO₃ on silica. 40.0 g of silica sphere and 43.78 g of 34% K₂CO₃ solution was weighed. A rotary impregnation was set up to spray the 34% K₂CO₃ solution on to the silica sphere at a given rate. The rotary impregnation was rotated for about 5 to about 10 minutes, where the catalysts were observed for any uniformity change. The impregnated sample was left to sit at room temperature for at least 30 minutes. After sitting, the sample was then dried at 120° C. for at least 4 hours. The dried samples were then calcined at 300° C., 400° C., 500° C., 600° C., and 700° C.

### Example 3

A catalyst was prepared as follows to have 20.35% K₂CO₃ on silica. 40.0 g of silica sphere and 40.72 g of 25% K₂CO₃ solution was weighed. A rotary impregnation was set up to spray the 50% K₂CO₃ solution on to the silica sphere at a given rate. The rotary impregnation was rotated for about 5 to about 10 minutes, where the catalysts were observed for any uniformity change. The impregnated sample was left to sit at room temperature for at least 30 minutes. After sitting, the sample was then dried at 120° C. for at least 4 hours. The dried samples were then calcined at 300° C., 400° C., 500° C., 600° C., and 700° C.

### Example 4

A catalyst was prepared as follows to have 16.35% K₂CO₃ on silica. 40.0 g of silica sphere and 38.96 g of 20% K₂CO₃ solution was weighed. A rotary impregnation was set up to spray the 50% K₂CO₃ solution on to the silica sphere at a given rate and at room temperature. The rotary impregnation was rotated for about 5 to about 10 minutes, where the catalysts were observed for any uniformity change. The impregnated sample was left to sit at room temperature for at least 30 minutes. After sitting, the sample was then dried at 120° C. for at least 4 hours. The dried samples were then calcined at 300° C., 400° C., 500° C., 600° C., and 700° C.

### Example 5

A catalyst was prepared as follows to have 16% Cs₂CO₃ on silica. 20.0 g of silica sphere and 22.78 g of 17% Cs₂CO₃ solution was weighed. A rotary impregnation was set up to spray the 17% Cs₂CO₃ solution on to the silica sphere at a given rate and at room temperature. The rotary impregnation was rotated for about 5 to about 10 minutes, where the catalysts were observed for any uniformity change. The impregnated sample was left to sit at room temperature for at least 30 minutes. After sitting, the sample was then dried at 120° C. for at least 4 hours. The dried samples were then calcined at 300° C., 400° C., 500° C., 600° C., and 700° C.

### Example 6

A catalyst was prepared as follows to have 26% Cs₂CO₃ on silica. 40.0 g of silica sphere and 45.07 g of 32% Cs₂CO₃ solution was weighed. A rotary impregnation was set up to spray the 32% Cs₂CO₃ solution on to the silica sphere at a given rate and at room temperature. The rotary impregnation was rotated for about 5 to about 10 minutes, where the catalysts were observed for any uniformity change. The impregnated sample was left to sit at room temperature for at least 30 minutes. After sitting, the sample was then dried at 120° C. for at least 4 hours. The dried samples were then calcined at 300° C., 400° C., 500° C., 600° C., and 700° C.

### Example 7

A catalyst was prepared as follows to have 25% Cs₂CO₃ on activated carbon. 80.0 g of activated carbon extrudate and 52.0 g of 50% Cs₂CO₃ solution was weighed. The Cs₂CO₃ solution was diluted by adding deionized water to total volume of 68 cc (or ml). A rotary impregnation was set up to spray the 50% Cs₂CO₃ solution on to the activated carbon support at a given rate and at room temperature. The rotary impregnation was rotated for about 5 to about 10 minutes, where the catalysts were observed for any uniformity change. The impregnated sample was left to sit at room temperature for at least 30 minutes. After sitting, the sample was then dried at 110° C. for at least 1 hour.

### Example 8

A catalyst was prepared as follows to have 30% Cs₂CO₃ on activated carbon. 80.0 g of activated carbon extrudate and 70.0 g of 50% Cs₂CO₃ solution was weighed. The Cs₂CO₃ solution was diluted by adding deionized water to total volume of 68 cc (or ml). A rotary impregnation was set up to spray the 50% Cs₂CO₃ solution on to the activated carbon support at a given rate and at room temperature. The rotary impregnation was rotated for about 5 to about 10 minutes, where the catalysts were observed for any uniformity change. The impregnated sample was left to sit at room temperature for at least 30 minutes. After sitting, the sample was then dried at 110° C. for at least 1 hour.

### Example 9

A catalyst was prepared as follows to have 36% Cs₂CO₃ on activated carbon. 80.0 g of activated carbon extrudate and 90.0 g of 50% Cs₂CO₃ solution was weighed. The Cs₂CO₃ solution was diluted by adding deionized water to total volume of 68 cc (or ml). A rotary impregnation was set up to spray the 50% Cs₂CO₃ solution on to the activated carbon support at a given rate and at room temperature. The rotary impregnation was rotated for about 5 to about 10 minutes, where the catalysts were observed for any uniformity change. The impregnated sample was left to sit at room temperature for at least 30 minutes. After sitting, the sample was then dried at 110° C. for at least 1 hour.

### Example 10

A catalyst was prepared as follows to have 40% Cs₂CO₃ on activated carbon. 80.0 g of activated carbon extrudate and 107.0 g of 50% Cs₂CO₃ solution was weighed. The Cs₂CO₃ solution was diluted by adding deionized water to total volume of 68 cc (or ml). A rotary impregnation was set up to spray the 50% Cs₂CO₃ solution on to the activated carbon support at a given rate and at room temperature. The rotary impregnation was rotated for about 5 to about 10 minutes, where the catalysts were observed for any uniformity change. The impregnated sample was left to sit at room temperature for at least 30 minutes. After sitting, the sample was then dried at 110° C. for at least 1 hour.

### Example 11

A catalyst was prepared as follows to have 33% Cs₂CO₃ on alumina. 80.0 g of alumina extrudate and 90.5 g of 38% Cs₂CO₃ solution was weighed. The Cs₂CO₃ solution was diluted by adding deionized water to total volume of 62 cc (or ml). A rotary impregnation was set up to spray the 38% Cs₂CO₃ solution on to the alumina at a given rate and at room temperature. The rotary impregnation was rotated for about 5 to about 10 minutes, where the catalysts were observed for any uniformity change. The impregnated sample was left to sit at room temperature for at least 30 minutes. After sitting, the sample was then dried at 110° C. for at least 4 hours. The samples were then calcined after drying at 300° C., 400° C., 500° C., and 600° C.

### Example 12

A catalyst was prepared as follows to have 16.67% K₂CO₃ on alumina support. 250 g of alumina extrudate and 50.0 g of 50% K₂CO₃ solid was weighed and then dissolved to a total volume of 164.35 ml. The alumina support was put into a 45° inclined rotating drum with baffle, where the rotating speed was set at 30 RPM. The 50% K₂CO₃ solution was sprayed onto the catalyst while the drum was rotated and at room temperature. The catalyst was then dried in a muffle furnace by setting the heating rate at 2° C./min and holding at 110° C. for 30 minutes and then raise the temperature to 250° C. and holding for 2 hours. The catalyst was then cooled down to ambient temperature.

### Example 13

A catalyst was prepared as follows to have 15% K₂CO₃ on alumina. 160.0 g of activated carbon extrudate and 56.49 g of 50% K₂CO₃ solution was weighed. The K₂CO₃ solution was diluted by adding 98.61 g of deionized water. A rotary impregnation was set up to spray the 50% K₂CO₃ solution on to the activated carbon support at a given rate and at room temperature. The rotary impregnation was rotated for about 5 to about 10 minutes after all solution was added to the rotary impregnation. The impregnated sample was left to sit at room temperature for at least 30 minutes. After sitting, the sample was then dried at 110° C. for at least 1 hour.

### Example 14—RWGS Performance of Cs₂CO₃ on Carbon

The inventive catalyst samples were evaluated for CO₂ hydrogenation reaction as shown below:

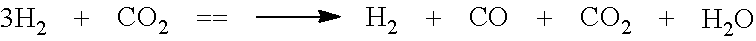

This reaction is called reversed water gas shift (RWGS) reaction. The reaction testing conditions were: pressure was 10 bar, total gas follow rate was 40 sccm (~3,500 ml h⁻¹, g⁻¹, WHSV=2 h⁻¹), the gas compositions: H₂ to CO₂ ratio was 3 to 1; reaction temperature in the range from 350 to 550° C.

Analysis of the reaction products found that CO₂ was 100% hydrogenate to CO and no methane formation was observed under these testing conditions. CO yield vs. reaction temperatures are summarized in the following table.

TABLE 1
CO % from RWGS on Cs₂CO₃ on Carbon
Catalyst at Different Temperatures

| | Reaction Temperature, ° C. | | | | | | |
|---|---|---|---|---|---|---|---|
| | 360 | 380 | 420 | 440 | 470 | 495 | 510 |
| CO % yield | 14.0 | 25.0 | 36.8 | 44 | 45 | 49.5 | 51.8 |

At reaction temperature around 440° C. CO yield reached theoretical yield of 44% CO with 100% selectivity. The catalyst continued to catalyze the reaction with theoretical CO yield at around 475° C. The catalyst gave 100% CO selectivity from 350° C. to 475° C. without forming methane and other by-products. The results demonstrate that this catalyst not only has high activity for CO₂ hydrogenation but also with high selectivity to CO at lower and medium temperatures. When compared with other metal catalysts, such as Ni, Pt or Pd catalysts, this catalyst has higher activity and selectivity at lower to medium temperatures (from 400° C. to 650° C.). Most of the metal catalysts for RWGS require higher reaction temperatures and typically forming methanation as by-product that lower CO selectivity and coking on catalyst surface. Other advantages of running at lower temperature make this process more sustainable especially for carbon net zero and carbon neutrality management.

### Example 15

XRD analysis was performed showing that the catalyst included mostly amorphous metal carbonate due to being highly dispersed on support.

### XRD Analysis Methodology

### Preparation Methodology

The sample was ground to a fine powder using mortar and pestle and then backpacked into a round mount sample holder. The sample holder was loaded onto a sample spinner during data acquisition to improve particle counting statistics with a sample rotation time of 1 s. The data collection from the round mount covered a range from 15° to 90° 2θ using a continuous scan with a step size of 0.0167° 2θ and a scan speed of 0.011° 2θ per second (200 s time per step). A graphite monochromator was used to strip unwanted radiation, including Cu KB radiation.

### Analysis Methodology

Panalytical HighScore version 4.5 software and ICDD PDF-4+2021 version 4.2103 powder diffraction file database was used for phase identification analysis.

### Instrumentation

A PANalytical Empyrean diffraction system with a copper anode tube was operated with generator settings at 45 kV and 40 mA to produce Cu Kal radiation of wavelength 1.54060 Å used to generate data. The optical path consisted of a 0.04 rad primary soller slit, 15 mm beam mask, 1° divergence slit, 2° anti-scatter slit, the sample, a 0.02 rad secondary soller slit, a monochromator and an X'Celerator position sensitive detector. No beam knife was used.

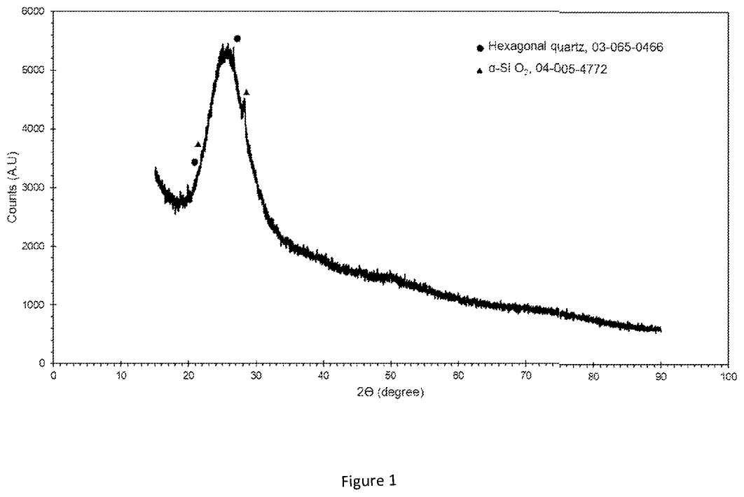

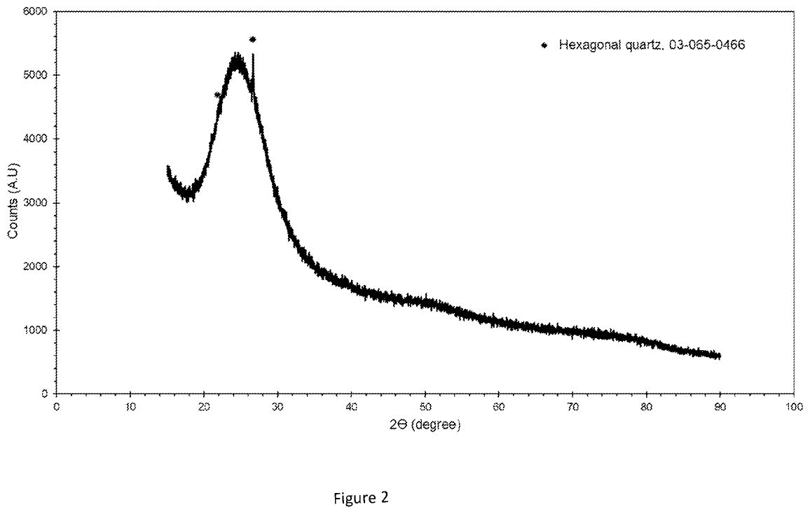

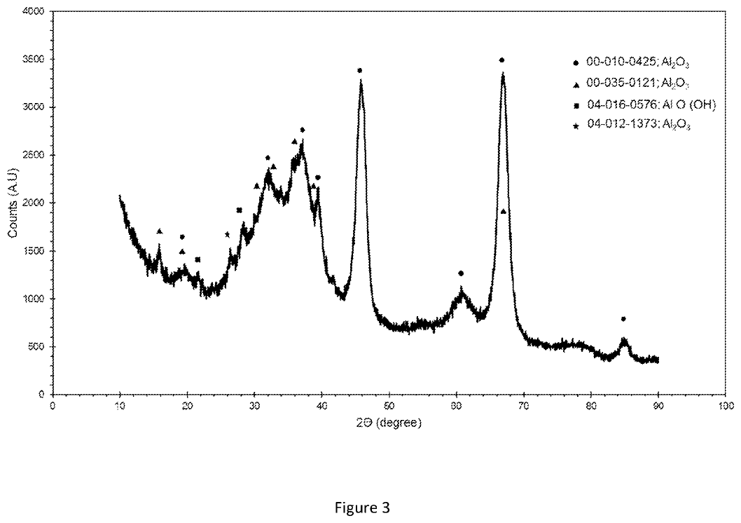

The results of the XRD analysis are shown in FIGS. 1-3. From the XRD analysis, the pattern is indicative of high amorphous metal carbonate content because no identifiable XRD pattens related Cs₂CO₃ or K₂CO₃ were detected. All XRD pattens are associated with a possible crystalline phase candidates of hexagonal quartz and/or hexagonal silica that were from silica support. The XRD results (FIG. 1 and FIG. 2) further show that the Cs₂CO₃ was highly dispersed in amorphous form. FIG. 3 XRD pattens show that Cubic γ-alumina (γ-Al₂O₃; ref id: 00-010-0425), rhombohedral α-alumina (ref id: α-Al₂O₃; ref id: 04-012-1373), orthorhombic δ-alumina (δ-Al₂O₃; ref id: 04-016-0576) and or monoclinic θ-alumina (θ-Al₂O₃; ref id: 00-035-0121) are good phase candidates matching well with the sample's pattern. No K₂CO₃ crystal phases was detected. This demonstrated that K₂CO₃ was highly dispersed in amorphous form on alumina support.

For simplicity of explanation, the embodiments of the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events.

In the foregoing description, numerous specific details are set forth, such as specific materials, dimensions, processes parameters, etc., to provide a thorough understanding of the present invention. The particular features, structures, materials, or characteristics may be combined in any suitable manner in one or more embodiments. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. Reference throughout this specification to “an embodiment”, “certain embodiments”, or “one embodiment” means that a particular feature, structure, or characteristic described in connection with the embodiment is included in at least one embodiment. Thus, the appearances of the phrase “an embodiment”, “certain embodiments”, or “one embodiment” in various places throughout this specification are not necessarily all referring to the same embodiment.

The present invention has been described with reference to specific exemplary embodiments thereof. The specification and drawings are, accordingly, to be regarded in an illustrative rather than a restrictive sense. Various modifications of the invention in addition to those shown and described herein will become apparent to those skilled in the art and are intended to fall within the scope of the appended claims.

1. A catalyst comprising a metal carbonate comprising potassium (K), cesium (Cs), or sodium (Na), and a support, wherein the metal carbonate is amorphous.

2. The catalyst of claim 1, wherein the support comprises carbon, alumina, silica, zirconia, titania, ceria or a combination thereof.

3. The catalyst of claim 1, wherein the metal carbonate comprises K.

4. The catalyst of claim 1, wherein the metal carbonate comprises Cs.

5. (canceled)

6. The catalyst of claim 1, wherein the metal carbonate is included in an amount of about 10% to about 45% by weight, based on total weight of the catalyst.

7. (canceled)

8. (canceled)

9. The catalyst of claim 1, wherein the support is an alumina support.

10. The catalyst of claim 1, wherein the support is a carbon support, optionally wherein the carbon support is activated carbon.

11. (canceled)

12. The catalyst of claim 1, wherein the support is a silica support.

13. (canceled)

14. The catalyst of claim 1, wherein the catalyst has activity for CO₂ hydrogenation.

15. The catalyst of claim 1, wherein the catalyst has selectivity to CO during a reverse water-gas shift (RWGS) reaction at a temperature of about 350° C. to about 750° C.

16. (canceled)

17. (canceled)

18. A method comprising preparing a catalyst comprising a metal carbonate comprising potassium (K), cesium (Cs), or sodium (Na), and a support, wherein the metal carbonate is amorphous,
the method comprising mixing the metal carbonate and the support.

19. (canceled)

20. The method of claim 18, comprising spraying the metal carbonate solution on the support.

21. The method of claim 18, further comprising drying the catalyst and subsequently further calcining the catalyst at a temperature of about 300° C. to about 700° C.

22. (canceled)

23. (canceled)

24. The method of claim 18, wherein the support comprises carbon, alumina, silica, zirconia, or a combination thereof.

25. (canceled)

26. (canceled)

27. (canceled)

28. The method of claim 18, wherein the metal carbonate is included in an amount of about 10% to about 45% by weight, based on total weight of the catalyst.

29. A method for performing a reversed water gas shift reaction comprising applying the catalyst of claim 1.

30. (canceled)

31. The method of claim 29, wherein the catalyst has about 100% CO selectivity from about 350° C. to about 500° C.

32. The method of claim 29, wherein the catalyst has at least about 98% CO selectivity at a temperature up to about 650° C.

33. The method of claim 29, wherein the catalyst has about 100% CO selectivity from about 350° C. to about 500° C. and at least about 98% CO selectivity at a temperature up to about 650° C.

34. (canceled)

35. The method of claim 29, wherein the method produces less than about 5% methane at a temperature of up to 650° C.

36. (canceled)

37. (canceled)

38. (canceled)
